(19) United States
(12) Patent Application Publication
(10) Pub. No.: US 2021/0315223 A1
(43) Pub. Date: Oct. 14, 2021

(54) COMPOSITION OF A MILK-CONTAINING BEVERAGE CONTAINING SPECULOOS AND METHOD OF PREPARING IT

(71) Applicants: Geoffrey Molders, Sint-Pauwels (BE); Stefan De Maeyer, Stekene (BE)

(72) Inventor: Stefan De Maeyer, Stekene (BE)

(21) Appl. No.: 17/290,530

(22) PCT Filed: Oct. 2, 2019
(86) PCT No.: PCT/IB2019/058371

§ 371 Date: Apr. 30, 2021

(30) Foreign Application Priority Data
Oct. 3, 2018 (BE) 201805676

(51) Int. Cl. A23C 9/156; A23C 9/14; A23C 9/15; A23C 9/152; A23C 11/10; A23P 10/22

(52) U.S. Cl. CPC A23C 9/156; A23C 9/14; A23P 10/22; A23C 9/1528; A23C 11/103; A23C 9/1516

(57) ABSTRACT

Method (1) for preparing a milk-containing beverage containing speculoos (8), consisting of the following steps:—removal of the milk fat fraction (5) from the milk by centrifugation or churning,—grinding of speculoos (2) into speculoos powder (4) dispersion of fine speculoos powder (4) in the milk fat fraction (5) of the whole milk (3) by mixing the milk fat fraction and the speculoos powder at high speed in a dispersing mixer (10), a high-friction disperser (12) or in a. disintegrator/dissolver (21);—adding the resulting dispersion (6) to skimmed milk (7) or low-fat milk in a proportion that restores or approximates the original milk fat content in the whole milk (3); intensely mixing the dispersion (6) with the skimmed (7) or low-fat milk to a stable dispersion of the speculoos powder (4) in the milk.

### CROSS-REFERENCE TO RELATED APPLICATIONS

The present application is the National Phase entry of International Patent Application No. PCT/IB2019/058371 filed Oct. 17, 2019, the entire contents of which are hereby incorporated by reference into this application.

### TECHNICAL FIELD

The present disclosure relates to the composition of a milk-containing beverage containing speculoos and a method for preparing it.

More specifically, the present disclosure is intended for the production of milk-containing beverages with a speculoos taste.

### BACKGROUND

It is well known that milk with all kinds of flavourings is offered on the market, such as chocolate milk, or milk with raspberry flavouring and so on.

Speculoos is usually eaten as a cookie with coffee or at breakfast.

Traditionally, speculoos is made from the main ingredients flour, dark brown sugar and unsalted cold butter, and a chicken's egg, and from the secondary ingredients cooking salt, sodium bicarbonate and speculoos herbs.

These ingredients are processed into a dough which is baked in an oven at a temperature of, for example, 180° C. for half an hour.

The baking process produces the characteristic taste of speculoos. What are the chemical reactions?

Although complex chemical reactions occur during the entire baking process, the following two reactions are strongly involved in the formation of the characteristic speculoos taste.

First, the Maillard reaction, also called non-enzymatic browning, which are reactions that occur between reducing sugars and amino acids, the building blocks of proteins such as in the chicken egg.

Secondly, the caramelization reaction, which is also accompanied by a browning, which is a form of oxidation of sugar, or in other words a reaction of sugar with oxygen.

The characteristic taste of speculoos only arises after baking the speculoos dough. If one wants to keep this taste, one will have to start from speculoos that is already baked.

If one wants to obtain speculoos milk, one must succeed in incorporating baked speculoos in a milk-containing beverage in a stable manner, so that the beverage remains homogeneous and can be sold as a beverage.

Cow's milk contains proteins (3 to 4%), fats (3.5% to 5%), lactose (4.5% to 5%) and less than 1% minerals.

Cow's milk, but also other types of milk such as goat's milk or soya milk, contains fats that remain dissolved in the milk and do not precipitate.

Cow's milk also contains proteins that remain dissolved as long as the milk has a neutral pH, so that the milk proteins, mainly casein, do not reach their iso-electric point and do not precipitate.

By centrifuging cow's milk, a layer of fat will separate at the top. By churning the milk, the fat separates as butter and cream, leaving skimmed milk or buttermilk.

At the right pH (6 to 8), milk forms an emulsion in which milk fats can remain dissolved within certain limits.

If one wants to add speculoos to milk, one will first try to grind the baked speculoos as finely as possible without losing any of its taste. This can vary depending on the type of speculoos.

If the finely ground speculoos is added to milk, the speculoos particles will sag and gather as a precipitate at the bottom of the milk.

### SUMMARY

The present disclosure aims to solve these and other disadvantages by providing a composition of a milk-containing beverage with speculoos taste, and a method that allows a stable dispersion of speculoos in a milk-containing beverage.

The method of preparing speculoos in a milk-containing beverage according to the present disclosure consists of the following steps:
removal of the milk fat fraction from the milk by centrifugation or churning;
grinding of speculoos into speculoos powder to a minimum grain size without losing the taste of the speculoos;
dispersing fine speculoos powder in the milk fat fraction of the whole milk by mixing the milk fat fraction and the speculoos powder at a high speed of up to 10,000 rpm in a dispersing mixer or dispersing it in a high-friction disperser or in a disintegrator/dissolver;
adding the dispersion obtained to the skimmed milk or low-fat milk in a proportion that restores or approximates the original milk fat content in the milk;
intense mixing of the dispersion with the skimmed or low-fat milk until a stable dispersion of the speculoos powder in the milk is obtained.

In some embodiments, the grinding of speculoos to speculoos powder, the dispersing of speculoos powder in the milk fat fraction and the addition of the obtained dispersion to the skimmed milk are carried out at a refrigerator temperature in order to preserve the flavourings and to avoid overheating.

In some embodiments, while preparing milk containing speculoos, the pH of the mixture should be kept neutral between pH 6 and 8, in order to avoid any denaturation of milk proteins.

In the dispersion step, an animal or vegetable emulsion stabiliser such as egg yolk lecithin or soya lecithin can be added if necessary.

The milk used to add the speculoos flavourings may be of animal origin, such as cow's milk or goat's milk, but it may also be of vegetable origin, such as soya milk.

Also the milk fats used to prepare dispersions containing speculoos may be of animal or vegetable origin, such as milk cream or soya cream.

In some embodiments, the concentration of milk fats in the milk-containing beverage after the addition of the speculoos dispersion is equal to or approximates the concentration of milk fats in the milk before the milk fat fraction was removed.

The dispersion step can be carried out in a table dispersing mixer that can achieve high rotational speeds (10,000 rpm) and that is equipped with a temperature control such as a Thermomix® device.

The dispersion step can also be carried out in a high-friction dispersion device such as a device with a rotor/stator head such as a Silverson® Batch Mixer, where the rotor presses a mixture through a stator at high speed, causing the mixture to be emulsified or dispersed. The rotor/stator technique allows to achieve emulsions with a droplet size of 2 to 5 microns. The more frictional energy is provided, the smaller the droplets in emulsion or the speculoos granules in dispersion become, which promotes the stability of the emulsion or dispersion.

It is also possible to integrate the grinding of the speculoos and the dispersing of the ground powder in milk fat in a single process by using a Duplex disintegrator/dissolver such as Silverson®. This device is equipped with two working heads that work in opposite directions, with the top head pulling material down from the surface of the mixture, while the bottom head pulls up material from the bottom.

This device is suitable when light or floating material such as a powder needs to be pulled down and quickly dispersed, and is also used in the food industry.

### BRIEF DESCRIPTION OF THE DRAWINGS

In order to better illustrate the characteristics of the present disclosure, the following applications of the method for preparing speculoos in a milk-containing beverage according to the present disclosure are described below, with reference to the accompanying drawings, in which:

FIG. 1 schematically shows a flow chart of the method according to the present disclosure;

FIG. 2 shows a temperature-controlled dispersing mixer in perspective;

FIG. 3 shows a high-friction disperser in perspective;

FIG. 4 shows a cross-section of the working head of a double disintegrator/dissolver device.

### DETAILED DESCRIPTION

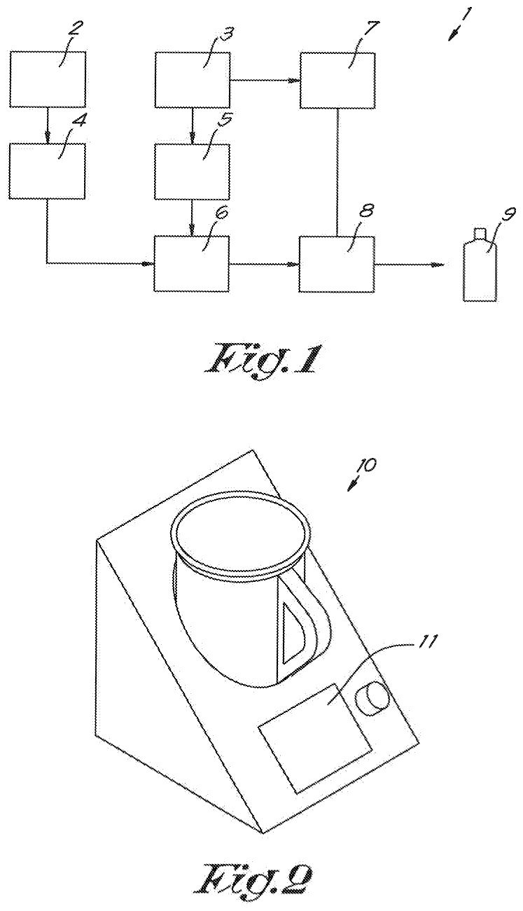

FIG. 1 shows a flowchart of method 1 according to the present disclosure based on baked speculoos 2 and whole milk 3, whereby the baked speculoos 2 is ground into a fine powder 4 and the whole milk 3 is skimmed by separating the milk fat 5. The fine speculoos powder 4 is then dispersed in the separated milk fat 5 in a dispersion step, after which the formed dispersion 6 is dissolved in the skimmed milk 7 which remained after separating the milk fat 5 from the whole milk 3. The resulting product is the speculoos in a milk-containing beverage 8 according to the present disclosure, which can be distributed in an individual drink packaging 9.

FIG. 2 shows a table dispersing mixer 10 which is provided with a temperature control 11 and which can achieve high rotational speeds (up to 10,000 rpm). The device allows, by mixing, to prepare an emulsion or dispersion at the desired temperature and with a programmed duration.

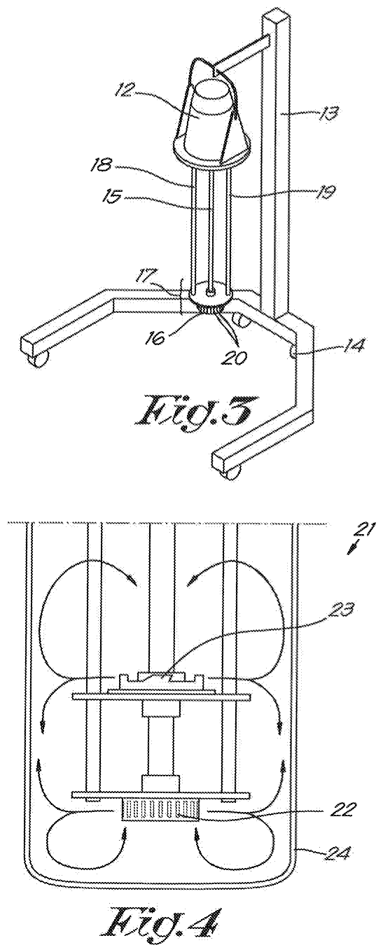

FIG. 3 shows a high-friction disperser 12, which in this case is suspended from a movable supporting structure 13 on wheels 14, so that the disperser 12 can be hung in a receptacle 24 for a batch preparation of an emulsion or a dispersion. The disperser 12 is equipped with a central rotor 15, which rotates at high speed, and which drives the mixture to be emulsified or dispersed through a stator 16, thus generating high friction forces and supplying energy to the mixture in the working head 17.

The stator 16 is fixed by two support rods 18, 19 while the rotor 15 sucks in the mixture from under the stator 16 through its rotation and then presses it at high speed through the openings 20 of the stator 16. There are several types of stators 16 available with different types of openings 20 depending on the desired purpose: emulsifying or disintegrating.

FIG. 4 shows a cross-section of a double disintegrator/dissolver 21 device. This device 21 is equipped with two working heads 22, 23 working in opposite directions, with the upper working head 23 pulling material downwards from the surface of the mixture, while the lower working head 22 is bringing material upwards from the bottom, making it suitable for pulling down a powder and quickly dispersing it in a liquid phase at the bottom of the receptacle 24 in which the working heads 22 and 23 are placed.

The method according to the present disclosure is very simple and as follows.

A quantity of speculoos 2 is ground into speculoos powder 4 in a mixer or blender. A quantity of speculoos powder, sufficient to give the intended quantity of milk-containing beverage a speculoos taste, is added to a receptacle 24 containing a quantity of milk fat 5, which corresponds to the milk fat content of the intended quantity of milk-containing beverage in the case of whole milk.

A disintegrator/dissolver 21 with two working heads 22, 23 is inserted into the receptacle 24 and put into operation to disperse the speculoos powder 4 in the milk fat phase 5. If necessary, an emulsion stabiliser such as lecithin can be added.

In some embodiments, this operation may be carried out at refrigerator temperature in order to preserve the flavourings of the speculoos fraction.

As soon as a homogeneous dispersion is formed, the dispersion is added to the target quantity of milk, which is now skimmed or low-fat milk, thus restoring the original concentration of milk fat 5 in the whole milk.

The mixture is mixed again at refrigerator temperature and the stable dispersion is then stored in a milk-containing beverage and distributed in individual packages.

It goes without saying that other mixers, stirrers or dispersers may also be used, provided that they have a sufficient dispersing effect.

It goes without saying that the milk used and the milk fat used may also be of vegetable origin, such as soya milk or soya cream.

It also goes without saying that the emulsion stabilizer may be of animal or plant origin such as egg yolk lecithin or soy lecithin.

In another embodiment, the milk-containing beverage containing speculoos is lyophilised to form milk powder containing speculoos which can be sold in that form and can be converted back into a milk-containing beverage containing speculoos by adding water at another point.

It goes without saying that the milk-containing beverage containing speculoos may also take the form of a yoghurt or a coffee-containing beverage, which can be presented as such or as a lyophilised powder.

In yet another embodiment, no speculoos powder is used to add the taste of speculoos to the milk-containing beverage, but only speculoos spices and sugar are added to the milk-containing beverage, resulting in a low-calorie beverage with speculoos flavourings.

These speculoos spices may consist for example of cinnamon, coriander, nutmeg, cloves, ginger, cardamom and orange peels.

The present disclosure is by not limited to the embodiments described as examples and shown in the figures; on the contrary, such a method for preparing speculoos milk according to the present disclosure can be accomplished in several variants while still remaining within the scope of the present disclosure, as described in the following claims.

1. A method for preparing speculoos in a milk-containing beverage, the method comprising the following steps:
removing a milk fat fraction from whole milk by centrifugation or churning;
grinding speculoos into a speculoos powder;
dispersing the speculoos powder in the milk fat fraction of the whole milk by mixing the milk fat fraction and the speculoos powder at a speed up to 10,000 rpm in a dispersing mixer, a high-friction disperser, or a disintegrator/dissolver to form a dispersion;
adding the dispersion to skimmed milk or low-fat milk in a proportion that restores or approximates an original milk fat content in the whole milk; and
mixing the dispersion with the skimmed or the low-fat milk until a stable dispersion of the speculoos powder in the skimmed milk or the low-fat milk is obtained.

2. The method according to claim 1, wherein the grinding of the speculoos to the speculoos powder, the dispersing of the speculoos powder in the milk fat fraction, and the adding of the dispersion to the skimmed milk or the low-fat milk is carried out at refrigerator temperature to preserve flavourings and avoid overheating.

3. The method according to claim 1, wherein while preparing the beverage, a pH of the beverage is kept neutral between pH 6 and pH 8 in order to avoid any denaturation of milk proteins.

4. The method according to claim 1, wherein an animal emulsion stabiliser or a vegetable emulsion stabiliser is added in the dispersing step.

5. The method according to claim 1, wherein the skimmed milk or the low-fat milk is of animal origin, such as cow's milk or goat's milk, or of vegetable origin such as soya milk.

6. The method according to claim 1, wherein the milk fat fraction is of animal origin or of vegetable origin.

7. The method according to claim 1, wherein a concentration of milk fats in the milk-containing beverage after adding the dispersion is equal to a concentration of milk fats in the whole milk before the milk fat fraction was removed.

8. A composition of a milk-containing beverage containing speculoos, the composition comprising: ground speculoos powder dispersed in milk fat and forming a stable emulsion in the milk-containing beverage containing speculoos.

9. A composition of a milk-containing beverage containing speculoos, the composition comprising: speculoos that has been lyophilised to forma milk powder containing the speculoos which is sold in that form.

10. (canceled)

11. (canceled)

12. The method according to claim 4, wherein the animal emulsion stabiliser is added in the dispersing step.

13. The method according to claim 12, wherein the animal emulsion stabiliser is egg yolk lecithin.

14. The method according to claim 4, wherein the vegetable emulsion stabiliser is added in the dispersing step.

15. The method according to claim 14, wherein the vegetable emulsion stabilizer is soya lecithin.

16. The method according to claim 5, wherein the skimmed milk or the low-fat milk is of the animal origin.

17. The method according to claim 16, wherein the skimmed milk or the low-fat milk of the animal origin is one of cow's milk or goat's milk.

18. The method according to claim 5, wherein the skimmed milk or the low-fat milk is of the vegetable origin.

19. The method according to claim 18, wherein the skimmed milk or the low-fat milk of the vegetable origin is soya milk.

20. The method according to claim 6, wherein the milk fat fraction is of the animal origin, and the milk fat fraction of the animal origin is milk cream.

21. The method according to claim 6, wherein the milk fat fraction is of the vegetable origin.

22. The method according to claim 21, wherein the milk fat fraction of the vegetable origin is soya cream.
